(19) United States
(12) Patent Application Publication
(10) Pub. No.: US 2004/0191374 A1
(43) Pub. Date: Sep. 30, 2004

(54) Multi-stage method and apparatus for combined thermal and non-thermal pasteurization

(75) Inventors: Zhijun Weng, Fresno, CA (US); Kenneth Fox, Lakeland, FL (US); Juan Podesta, Wilmette, IL (US)

Correspondence Address: WOOD, HERRON & EVANS, LLP, 2700 CAREW TOWER, 441 VINE STREET, CINCINNATI, OH, 45202, US

(73) Assignee: FMC Technologies, Inc., Chicago, IL

(21) Appl. No.: 10/395,728

(22) Filed: Mar. 24, 2003

(51) Int. Cl. A23L 3/00

(52) U.S. Cl. 426/238

(57) ABSTRACT

A multi-stage system and method for pasteurizing food products includes a first processing unit configured to receive the food product and apply an amount of non-thermal energy treatment to the food product which is effective to inactivate one or more key enzymes. A second processing unit is configured to receive the food product from the first processing unit and reduces the population of potentially harmful microorganisms to a level that is not harmful to consumers of the food product. In one alternative embodiment, the second processing unit comprises a concentration unit which removes water from the food product to produce a concentrated form of the product. The first processing unit may, for example, comprise a high voltage arc discharge unit, a non-thermal pulsed electric field unit, an oscillating magnetic field unit, or an ultrasonic unit.

### FIELD OF THE INVENTION

This invention generally relates to pasteurization or sterilization of food products and, more particularly, to methods and apparatus designed to pasteurize pumpable food products without significantly degrading characteristics of the food products such as flavors, colors, aromas, and/or nutritional value.

### BACKGROUND OF THE INVENTION

Various methods of pasteurizing food products have been developed over the years. Most of the commercial processes for pasteurizing pumpable food products, such as juices, pastes, relishes, sauces, and other foods, involve heating the product to a process temperature above 190° F. and holding it at that process temperature for a scheduled process time and then rapidly cooling the product prior to packaging. Unfortunately, methods involving high heat such as this can sometimes damage the food product and reduce its quality. For example, flavors may be reduced, desirable colors may be lost, and nutritional value may diminish. Thus, while conventional thermal processing has become the predominant commercial pasteurization method, the overall quality of the food products would be greatly increased if the drawbacks of high heat processing were reduced or eliminated.

A number of processes have been developed and proposed related to non-thermal methods of pasteurization. For example, these processes include ultra filtration, ozonation, ultraviolet light, irradiation, high hydrostatic pressure (HHP) and pulsed electric field (PEF) discharge. Other non-thermal technologies useful for this purpose include high voltage arc discharge, oscillating magnetic field discharge and ultrasonic discharge. Of these, PEF and HHP technologies have received considerable attention and research in recent years.

While various non-thermal processing methods, such as PEF discharge, have been shown to be effective for reducing the population of viable microorganisms and inactivating various key enzymes in food products, they still are not as effective as conventional thermal processing, especially in a commercial food processing environment. Such an environment can require continuous throughput of up to more than 100 GPM for liquid food products such as juices or more viscous pumpable products such as sauces or pastes. However, it has been found that certain non-thermal pasteurization systems such as certain PEF discharge systems, can be effective to adequately reduce enzymatic activity but may not reduce microorganism population to acceptable levels.

To address the current problems with achieving commercially acceptable non-thermal pasteurization, it would be desirable to provide pasteurization methods and apparatus which reduce or eliminate high temperature thermal processing and thereby minimize degradation of the food product but, at the same time, overcome current non-thermal processing drawbacks.

### SUMMARY OF THE INVENTION

The present invention generally relates to a multi-stage pasteurization system and method for pasteurizing food products containing at least one enzyme which can reduce the quality of the food product and a population of at least one microorganism which can cause spoilage, undesirable flavors, undesirable odors or health concerns if ingested in sufficient quantity by the consumer. The system generally comprises a first processing unit configured to receive the food product and apply an amount of non-thermal energy treatment to the food product. The amount of non-thermal energy treatment is effective to inactivate the enzyme in the food product. This means that the enzymatic activity is reduced to industry accepted levels for the food product under treatment. The system further comprises a second processing unit configured to receive the food product from the first processing unit and effectively reduce the population of the microorganism in the food product to a level acceptable for a desired product shelf life and that is not harmful to the consumer of the food product. The microorganisms may include, for example, bacteria, yeast, mold and/or other potentially harmful pathogens.

In the preferred embodiment, the second processing unit is a thermal treatment unit in which the food product is subjected to temperatures substantially lower than conventional pasteurization temperatures used on the same type of food product. Alternatively, the second processing unit may be a high static pressure system as known in the art. In each case, the resulting processed food will have better flavor, color, aroma and/or nutritional value than achieved by conventional thermal processing. This two stage system and the two stage corresponding method may be expanded into further stages, such as by including chilling, concentration, evaporation, or other processes depending on the requirements of the food product.

The first processing unit may, for example, be comprised of a high voltage arc discharge unit, a non-thermal pulsed electric field unit, an oscillating magnetic field unit, an ultrasonic unit or other suitable non-thermal processing units. The term “non-thermal” is not meant to convey that no heat is generated during treatment but encompasses methods which generate nominal heat that does not cause the system to reach pasteurization temperatures.

In another aspect of the invention, a multi-stage pasteurization system includes the first processing unit as described above and a second processing unit which is configured as a concentration unit to remove water from a pumpable, water-containing food product. The concentration portion of the system may or may not provide thermal pasteurization in this aspect of the invention.

As mentioned above, the invention contemplates corresponding methods of processing a food product which includes applying non-thermal energy treatment to the food product in an amount to effectively inactivate one or more enzymes in the food product. In accordance with the invention the method further includes pasteurizing the food product and/or concentrating the food product by removing water therefrom.

The food product may, for example, be derived from fruits and/or vegetables and comprise juices, pastes, sauces, or other pumpable products. When pasteurizing the food product in a thermal pasteurization step, the food product is preferably heated to a temperature up to a maximum of about 160° F. This is significantly below conventional pasteurization temperatures and can preserve flavor, aroma, color, nutritional value and other desirable characteristics of the food product to a much greater extent than higher temperature pasteurization.

These and other objects, advantages, and features of the invention will become more readily apparent to those of ordinary skill in the art upon review of the following detailed description taken in conjunction with the accompanying drawings.

### BRIEF DESCRIPTION OF THE DRAWINGS

FIG. 1 is a block diagram illustrating a first embodiment of the invention comprising a food processing system having a non-thermal enzyme deactivation step and a low temperature pasteurization step.

FIG. 2 is a block diagram illustrating a second embodiment of a system such as that shown in FIG. 1, but adding an evaporation step to the process.

FIG. 3 is a block diagram illustrating a third embodiment of the invention comprising a food processing system having a non-thermal enzyme deactivation step coupled with a concentration step.

FIG. 4 is a block diagram illustrating a fourth embodiment of the invention comprising a system especially suitable for making tomato paste.

### DETAILED DESCRIPTION OF THE DRAWINGS

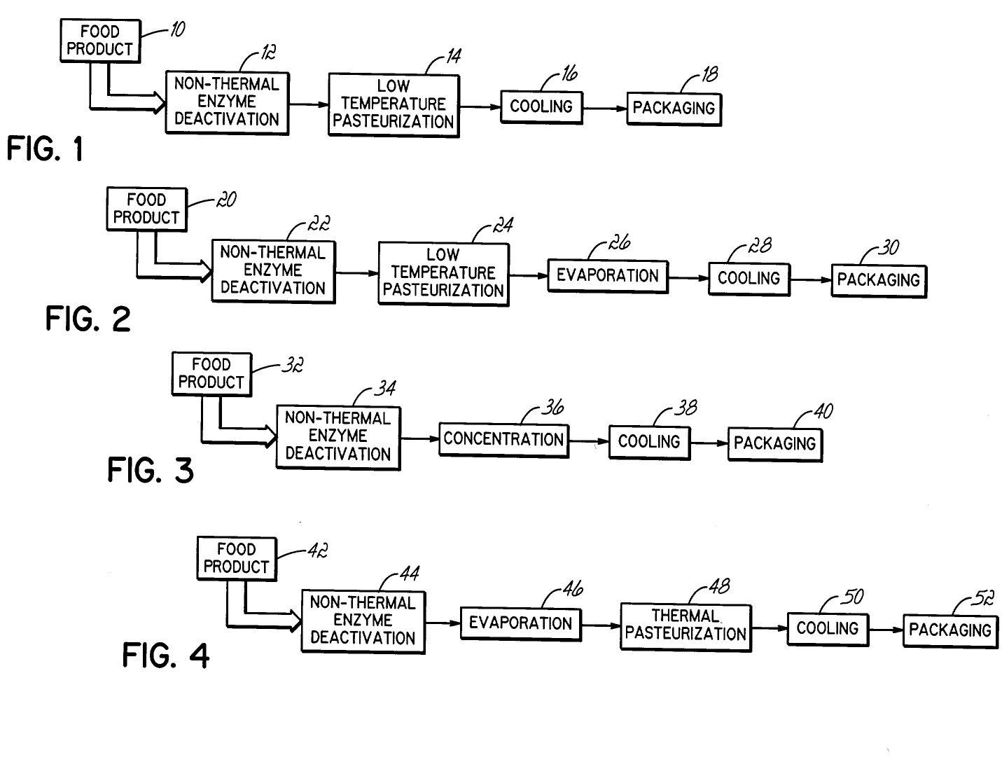

FIG. 1 illustrates a first embodiment of an enclosed aseptic food processing system schematically illustrated to include a food product supply 10, a non-thermal enzyme deactivation unit 12, a low temperature pasteurization unit 14, a cooling unit 16, and a packaging unit 18. It will be appreciated that additional stations or units may be incorporated into this system depending on the processing needs of the particular food product. As one of many illustrative food products, orange juice or other types of juices may be pasteurized in this system and, for example, the non-thermal enzyme deactivation unit 12 may more specifically comprise a high voltage arc discharge system, which is available from Scientific Utilization Inc. (Huntsville, Ala.) or a pulsed electric field (PEF) discharge unit which is submerged in the juice. The PEF discharge unit 12 may, for example, comprise a high-voltage pulser and a PEF treatment chamber available from Maxwell Technologies, Inc. (San Diego) or Thomson-CSF (France). Enzyme deactivation unit 12 should reduce enzymatic activity to industry acceptable levels. For orange juice as one example, usually a 99% reduction of enzymatic activity is considered acceptable.

Especially in commercial production environments, known high voltage arc discharge systems or PEF units such as the type described may not reduce the population of viable microorganisms in the food product to acceptable levels. In accordance with the invention, therefore, a low temperature pasteurization unit, such as a tubular sterilization unit available from FMC Technologies, Inc. (Chicago, Ill.), is used in the system and receives the juice product from the high voltage arc discharge system or PEF unit. At this station 14, the pumpable food product is heated to about 160° F. (+/−0.5° F.) for a time duration sufficient to reduce the population of the microorganism(s) of concern to industry accepted levels, such as by a minimum of a 5 log reduction. Subsequently, the juice product is cooled in a conventional cooling unit 16 and subsequently packaged by a packaging unit 18. Cooling and packaging units 16, 18 may be combined or positioned in opposite order than shown. In the described manner, commercial processing and pasteurization of the juice may be carried out at a desired commercial throughput while retaining the flavors, aroma, color and nutritional value of the product in its fresh state.

FIG. 2 illustrates another enclosed aseptic food pasteurization system including a food product supply 20, a non-thermal enzyme deactivation unit 22 and a low temperature pasteurization unit 24 which may each take the forms described above. In addition, this second embodiment includes an evaporation unit 26 upstream from a cooling unit 28 and packaging unit 30 which, again, may be conventional portions of the system. The evaporation unit 26 is incorporated into this system to form a concentrated product such as concentrated orange juice. It may also be desirable to combine the low temperature pasteurization unit 24 and the evaporation unit 26 such that low temperature pasteurization and evaporation processes are performed simultaneously. That is, the orange juice may be heated to a temperature of about 160° F. as water is removed from the juice in an evaporation process during which the 160° F. temperature is maintained for a time sufficient to pasteurize the orange juice.

FIG. 3 illustrates another alternative embodiment of an enclosed aseptic food processing system designed to form a concentrate of a pumpable, water-containing food product. The food product is pumped from a supply 32 to a non-thermal enzyme deactivation unit 34, which again may be comprised of a submerged high voltage arc discharge system or a PEF discharge unit as described above. A concentration unit 36 receives the pumpable food product from the non-thermal enzyme deactivation unit 34 and may more specifically comprise a multi-stage evaporator system available from FMC Technologies, Inc. (Chicago, Ill.). Such a concentration unit 36 may or may not achieve a pasteurization temperature depending, for example, on the pressure applied to the pumpable food product during this portion of the process. However, it will be understood by those of ordinary skill that concentrated forms of various food products need not be pasteurized if the concentrated form of the food product itself does not allow adequate microbial growth. As with the previous systems, this system also includes conventional cooling and packaging units 38, 40 which may or may not be combined into a single apparatus and which may be reversed in order.

FIG. 4 illustrates another embodiment of the invention which is particularly suitable for the production of tomato pastes. In this system, a food product supply 42, which may contain tomato juice, supplies a non-thermal enzyme deactivation unit 44, such as a unit as described above. Following enzyme deactivation, the juice is sent to an evaporation unit 46. Evaporation unit 46 removes water from the tomato juice to form a tomato paste. The tomato paste is then directed into a thermal pasteurization unit 48 prior to being cooled and packaged at respective stations 50, 52 which may be configured as previously described. With respect to the production of tomato paste, the thermal pasteurization unit 48 usually achieves conventional pasteurization temperatures of between about 200° F. ard 215° F. Although this may have some adverse effect on the quality of the resulting tomato paste due to the higher temperatures than used in connection with other embodiments of this invention, the non-thermal enzyme deactivation station 44 replaces the conventional first high temperature hot break step and thus, overall, the food product is subjected to high temperatures for a shorter period of time than in conventional processing techniques. For this reason, the resulting food product (e.g., tomato paste) has better flavor, aroma, color and nutritional value than it would if processed with conventional thermal pasteurization only.

While the present invention has been illustrated by a description of a preferred embodiment and while this embodiment has been described in some detail, it is not the intention of the Applicants to restrict or in any way limit the scope of the appended claims to such detail. Additional advantages and modifications will readily appear to those skilled in the art. The various features of the invention may be used alone or in numerous combinations depending on the needs and preferences of the user. This has been a description of the present invention, along with the preferred methods of practicing the present invention as currently known. However, the invention itself should only be defined by the appended claims.

What is claimed is:

1. A multi-stage system for pasteurizing a food product containing at least one enzyme which can reduce the quality of the food product and containing a population of at least one microorganism, the system comprising:
a first processing unit configured to receive the food product and apply an amount of non-thermal energy treatment to the food product which is effective to inactivate the enzyme, and
a second processing unit configured to receive the food product from the first processing unit and effectively reduce the population of the microorganism.

2. The multi-stage pasteurization system of claim 1, wherein said first processing unit comprises at least one of:
a high voltage arc discharge unit, a non-thermal pulsed electric field unit, an oscillating magnetic field unit, and an ultrasonic unit.

3. The multi-stage pasteurization system of claim 1, wherein said second processing unit comprises at least one of a thermal pasteurization unit and a high static pressure system.

4. The multi-stage pasteurization system of claim 1, wherein said first and second processing units are configured to continuously receive, process, and discharge the food product.

5. The multi-stage pasteurization system of claim 4, wherein said second processing unit is configured to heat and cool the liquid food product.

6. The multi-stage pasteurization system of claim 1, further comprising an evaporation unit which removes water from the liquid food product to form a concentrate of the liquid food product.

7. The multi-stage pasteurization system of claim 6, wherein said second processing unit includes said evaporation unit.

8. A multi-stage method of pasteurizing a food product containing at least one enzyme which can reduce the quality of the food product and containing a population of at least one microorganism, the method comprising:
(a) applying a non-thermal energy treatment to the food product in an amount to effectively inactivate the enzyme, and
(b) pasteurizing the food product to effectively reduce the population of the microorganism.

9. The multi-stage method of claim 8, wherein applying the non-thermal energy treatment further comprises applying at least one of the following:
high voltage arc discharge radiation, pulsed electric field radiation, oscillating magnetic field radiation, and ultrasonic radiation.

10. The multi-stage method of claim 8, wherein pasteurizing the food product further comprises applying heat to the food product.

11. The multi-stage method of claim 8, wherein pasteurizing the food product further comprises applying static pressure to the food product.

12. The multi-stage method of claim 8, further comprising:
continuously performing steps (a) and (b) in an enclosed aseptic system while moving the food product from an inlet to an outlet of the enclosed aseptic system.

13. The multi-stage method of claim 8, wherein the food product is a pumpable food product.

14. The multi-stage method of claim 13, wherein the pumpable food product is a fruit juice.

15. The multi-stage method of claim 14, wherein the fruit juice is orange juice.

16. The multi-stage method of claim 14, wherein the fruit juice is tomato juice

17. The multi-stage method of claim 14, wherein pasteurizing the fruit juice further comprises:
heating the fruit juice to a temperature up to a maximum of about 160° F.

18. The multi-stage method of claim 15, further comprising:
evaporating water from the fruit juice to form a concentrate.

19. The multi-stage method of claim 8, wherein pasteurizing the food product further comprises:
heating the food product to a temperature up to a maximum of about 160° F.

20. The multi-stage method of claim 8, wherein the food product is a pumpable food product and the method further comprises:
evaporating water from the pumpable food product to form a concentrate.

21. A multi-stage system for pasteurizing a pumpable, water-containing food product which further contains at least one enzyme which can reduce the quality of the food product and containing a population of at least one microorganism, the system comprising:
a first processing unit configured to receive the food product and apply an amount of non-thermal energy treatment to the food product which is effective to inactivate the enzyme, and
an evaporation unit which removes a portion of the water from the food product to produce a concentrated form of the food product.

22. The multi-stage system of claim 21, further comprising:
a heating unit which pasteurizes the concentrated form of the food product.

23. A multi-stage method of pasteurizing a pumpable, water-containing food product which further contains at least one enzyme which can reduce the quality of the food product and containing a population of at least one microorganism, the method comprising:
(a) applying a non-thermal energy treatment to the food product in an amount to effectively inactivate the enzyme, and
(b) removing a portion of the water from the food product to produce a concentrated form of the food product.

24. The multi-stage method of claim 23, further comprising:
thermally pasteurizing the concentrated form of the food product.

25. A multi-stage system for pasteurizing a pumpable food product containing at least one enzyme which can reduce the quality of the pumpable food product containing and a population of at least one microorganism which can be harmful to the consumer of the pumpable food product, the system comprising:
a non-thermal pulsed electric field unit configured to receive the pumpable food product and apply an amount of pulsed electric energy to the pumpable food product which is effective to inactivate the enzyme, and
a thermal pasteurization unit configured to receive the pumpable food product from the non-thermal pulsed electric field unit and heat the pumpable food product to a maximum temperature of about 160° F. to effectively reduce the population of the microorganism.

26. A multi-stage method of pasteurizing a pumpable food product containing at least one enzyme which can reduce the quality of the pumpable food product and containing a population of at least one microorganism, the method comprising:
(a) applying a pulsed electric field to the pumpable food product in an amount to effectively inactivate the enzyme, and
(b) heating the pumpable food product to a maximum temperature of about 160° F. for a time period sufficient to effectively reduce the population of the microorganism.
